(19) United States
(12) Patent Application Publication
(10) Pub. No.: US 2020/0036847 A1
(43) Pub. Date: Jan. 30, 2020

(54) OPERATION SUPPORT INFORMATION PROVIDING APPARATUS, OPERATION SUPPORT INFORMATION PROVIDING SYSTEM, AND NON-TRANSITORY RECORDING MEDIUM

(71) Applicant: Ryutaro SAKANASHI, Kanagawa (JP)

(72) Inventor: Ryutaro SAKANASHI, Kanagawa (JP)

(21) Appl. No.: 16/389,553

(22) Filed: Apr. 19, 2019

(30) Foreign Application Priority Data
Jul. 30, 2018 (JP) 2018-142996

(51) Int. Cl. H04N 1/00

(52) U.S. Cl. CPC H04N 1/00517; H04N 2201/0094; H04N 1/00392; H04N 1/00482

(57) ABSTRACT

An operation support information providing apparatus includes a memory and processing circuitry. The processing circuitry stores, in the memory, operation history information transmitted from a terminal device, the operational history information including a record of a series of touches performed by at least one user on a touchscreen of the terminal device in order to perform an operation procedure that includes a series of operations for executing a specific function. Further, the processing circuitry generates, based on the stored operation history information, operation support information indicating, for a particular operation procedure, a particular operation pattern that includes a particular series of operations for executing the specific function. Finally, the processing circuitry provides the operation support information to the terminal device to aid an operator of to the terminal device to perform the specific function.

### CROSS-REFERENCE TO RELATED APPLICATIONS

This patent application is based on and claims priority pursuant to 35 U.S.C. § 119(a) to Japanese Patent Application No. 2018-142996, filed on Jul. 30, 2018, in the Japan Patent Office, the entire contents of which are incorporated by reference.

### BACKGROUND

### Technical Field

The present disclosure relates to an operation support information providing apparatus, an operation support information providing system, and a non-transitory recording medium.

### Description of the Related Art

When a problem related to printing occurs in an image forming apparatus, operation manual information is extracted from a database and presented to a user. In the operation manual information, a solution corresponding to the problem is described, and history information on the print setting operation procedure is described, as disclosed in JP-2009-169604.

However, in conventional technologies, the operation manual information associated with a predetermined print operation procedure is presented. As a result, an accuracy of the presented operation manual information might be low, e.g., operation manual information on screens different in layout from the actually displayed screen might be presented. Further, there is a possibility that appropriate operation manual information cannot be presented when a printing operation procedure not associated with the operation manual information is performed.

### SUMMARY

An operation support information providing apparatus includes a memory and processing circuitry. The processing circuitry stores, in the memory, operation history information transmitted from a terminal device, the operational history information including a record of a series of touches performed by at least one user on a touchscreen of the terminal device in order to perform an operation procedure that includes a series of operations for executing a specific function. Further, the processing circuitry generates, based on the stored operation history information, operation support information indicating, for a particular operation procedure, a particular operation pattern that includes a particular series of operations for executing the specific function. Finally, the processing circuitry provides the operation support information to the terminal device to aid an operator of to the terminal device to perform the specific function.

### BRIEF DESCRIPTION OF THE SEVERAL VIEWS OF THE DRAWINGS

A more complete appreciation of the disclosure and many of the attendant advantages and features thereof can be readily obtained and understood from the following detailed description with reference to the accompanying drawings, wherein:

FIG. 1 illustrates an example of a configuration of an operation support information providing system according to an embodiment;

FIG. 2 illustrates an example of a hardware block diagram of a service providing device according to an embodiment;

FIG. 3 illustrates an example of a software block diagram of a service providing device according to an embodiment;

FIG. 4 illustrates an example of a sequence diagram for a data store process of an operation support information providing system according to an embodiment;

FIG. 5 illustrates an example of an event information store table according to an embodiment;

FIG. 6 illustrates an example of a flowchart for an operation support information generate process of a service providing device according to an embodiment;

FIG. 7 illustrates an example of operation pattern information generated by a data collect unit to an embodiment;

FIG. 8 illustrates an example of an operation pattern information store table according to an embodiment;

FIG. 9 illustrates an example of a sequence diagram for an application screen provide process in an operation support information providing system according to an embodiment;

FIG. 10 illustrates an example of a sequence diagram for an operation support information providing process in an operation support information providing system according to an embodiment;

FIG. 11 illustrates an example of an application screen displayed on an operation panel of a multifunction peripheral in an operation support information providing system according to an embodiment;

FIG. 12 illustrates an example of operation support information offered to a user in an operation support information providing system according to an embodiment;

FIG. 13 illustrates an example of operation pattern information generated by a data collect unit to a first modified example; and

FIG. 14 illustrates an example of a heat map offered to a user in an operation support information providing system according to a second modified example.

The accompanying drawings are intended to depict embodiments of the present disclosure and should not be interpreted to limit the scope thereof. The accompanying drawings are not to be considered as drawn to scale unless explicitly noted.

### DETAILED DESCRIPTION

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise.

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

In the following, embodiments of the present disclosure are described with reference to the accompanying drawings.

### (Configuration of Operation Support Information Providing System 10)

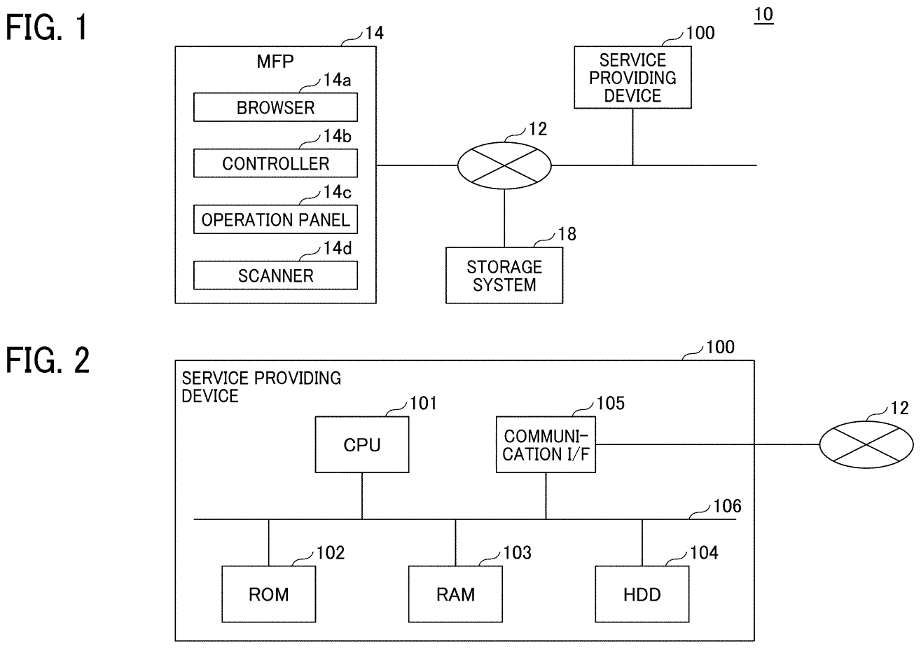

FIG. 1 illustrates an example of a configuration of the operation support information providing system 10 according to an embodiment. The operation support information providing system 10, shown in FIG. 1, includes a Multifunction Peripheral (MFP) 14, a storage system 18, and a service providing device 100. The MFP 14, the storage system 18, and the service providing device 100 are connected to a network 12, for example, an Internet, a corporate Local Area Network (LAN), a Virtual Private Network (VPN), etc.

The service providing device 100 is an example of the “operation support information providing apparatus.” The service providing device 100 can provide a device cooperation service and an operation support information providing service to each terminal device via the network 12. The “device cooperation service” is a cooperation service in which a service provided from the service providing device 100 can be used from each terminal device by cooperation between the service providing device 100 and each terminal device via the network 12. For example, as a device cooperation service, the service providing device 100 acquires scan data from the MFP 14 and causes the storage system 18 to store the scan data. The “operation support information providing service” is an information providing service that records and stores user operation information for a Web application for using the device cooperation service, and that provides, to each terminal device, the stored user operation information as operation manual information indicating an operation method for the Web application to each terminal device. As the service providing device 100, for example, a server device can be used.

In the present embodiment, an example of using the device cooperation service from the MFP 14 will be described. However, in the operation support information providing system 10, the device cooperation service can be used from each terminal device connectable to the network 12. The terminal device that uses the device cooperation service is not limited to the MFP, and any information processing device can be used as long as it is an information processing device that can perform user operations on at least the Web application. For example, a Personal Computer (PC), a smartphone, a tablet terminal, and a Personal Digital Assistant (PDA) can be used as a terminal device that uses the device cooperation service.

The MFP 14 is an example of an “image forming apparatus.” The MFP 14 is a terminal device having a plurality of image processing functions, such as a copy function, a scan function, a facsimile (FAX) function, a printer function, etc. The MFP 14 can mutually communicate with the service providing device 100 via the network 12. The MFP 14 can operate the Web application for the device cooperation service provided from the service providing device 100 via the Web browser. Further, the MFP 14 can acquire operation manual information of the Web application, by using the operation support information providing service provided from the service providing device 100.

The MFP 14 includes a browser 14a, a controller 14b, an operation panel 14c, and a scanner 14d. The browser 14a displays a display screen of various Web applications on the display of the operation panel 14c. Hereinafter, the display screen is also referred to as an “application screen.”

The browser 14a also accepts inputs to the various application screens from the operation panel 14c. The browser 14a also transmits and receives input/output data for the various application screens to/from the service providing device 100. Users can use the device cooperation service provided from the service providing device 100 via the application screen displayed on the browser 14a.

The controller 14b controls each function of the MFP 14. For example, the controller 14b controls each function of the MFP 14 by executing various programs stored in a read-only memory (ROM) or a hard disk drive (HDD) by a central processing unit (CPU), which is “processing circuitry.” The operation panel 14c includes a display for displaying various application screens and a touch panel for making selection on the various application screens. The scanner 14d optically reads a display content of a document and generates image data (e.g., a scan file) of the document.

The storage system 18 stores data handled by the service providing device 100. For example, the data includes a scan file outputted from the MFP 14. The storage system 18 is connected to the service providing device 100 via the network 12. As a result, the service providing device 100 can store the data in the storage system 18, and can read the data stored in the storage system 18.

(A Hardware Block Diagram of a Service Providing Device 100)

FIG. 2 illustrates an example of a hardware block diagram of the service providing device 100 according to an embodiment. As shown in FIG. 2, the service providing device 100 includes a Central Processing Unit (CPU) 101, a Read-Only Memory (ROM) 102, a Random-Access Memory (RAM) 103, a Hard Disk Drive (HDD) 104, and a communication Interface (IF) 105. Each hardware device is mutually connected via a bus 106.

The CPU 101 controls the entire service providing device 100 by executing various programs stored in the ROM 102 or the HDD 104. The ROM 102 is a nonvolatile memory. For example, the ROM 102 stores various programs to be executed by the CPU 101 and data necessary for the CPU 101 to execute various programs. The RAM 103 is a main storage device, such as a Dynamic Random Access Memory (DRAM), a Static Random Access Memory (SRAM), etc. For example, the RAM 103 functions as a work area used when the CPU 101 executes various programs.

The HDD 104 is a nonvolatile auxiliary storage device. For example, the HDD 104 stores various programs to be executed by the CPU 101, and data necessary for the CPU 101 to execute various programs. The communication IF 105 controls communication with the MFP 14, and the storage system 18 via the network 12.

(A Software Block Diagram of a Service Providing Device 100)

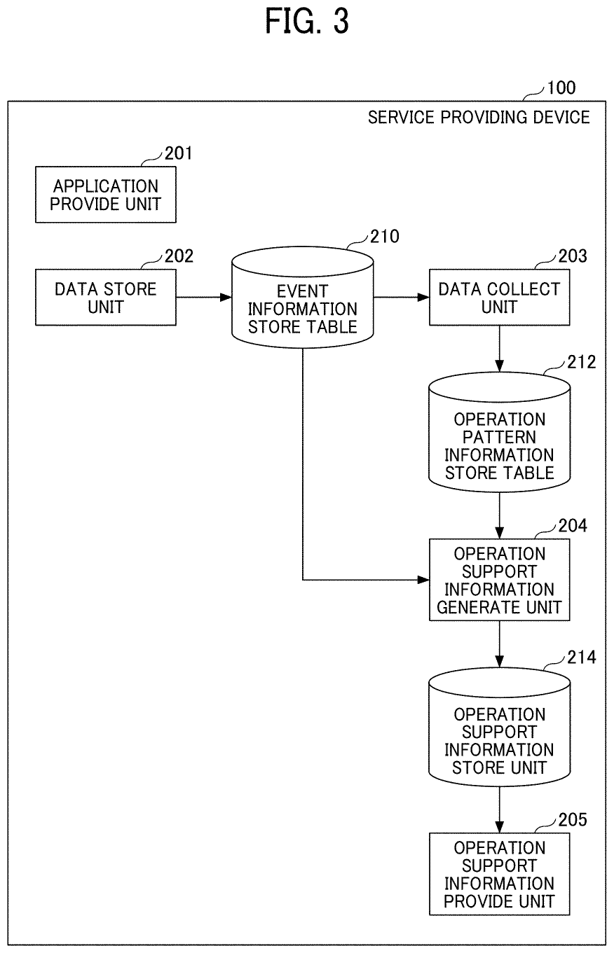

FIG. 3 illustrates an example of a software block diagram of the service providing device 100 according to an embodiment. As shown in FIG. 3, the service providing device 100 includes an application provide unit 201, a data store unit 202, a data collect unit 203, an operation support information generate unit 204, an operation support information provide unit 205, an event information store table 210, an operation pattern information store table 212, and an operation support information store unit 214.

The application provide unit 201 provides the application screen corresponding to the device cooperation service used by the user to the MFP 14 via the network 12. In the MFP 14, the browser 14a causes the operation panel 14c to display the application screen provided from the application providing unit 201.

The data store unit 202 is an example of a memory. The data store unit 202 stores the event information transmitted from the browser 14a. Specifically, each time the event information is transmitted from the browser 14a, the data storage unit 202 registers the event information in the event information storage table 210 stored in the memory of the service providing device 100. The event information is an example of “an operation history information.” That is, the event information is information specifying operation contents of a series of operations performed by the user on the application screen. In this embodiment, the event information includes a session identification (session ID), a Uniform Resource Locator (URL), coordinate values, and a screen shot image. The session ID is identification information issued for a series of operations for executing a specific function. That is, the same session ID is included in a plurality of the event information corresponding to the series of operations. The URL is information indicating the address of the application screen displayed on the browser 14a and touched by the user. The coordinate value is information indicating the position at which the touch operation is performed on the application screen by the user. The screen shot image is an image that is obtained by the screen shot function of the MFP 14 when the touch operation is performed on the application screen. The event information storage table 210 is described below with respect to FIG. 5.

The data collect unit 203 collects a plurality of event information items stored by the data store unit 202.

Specifically, the data collect unit 203 calculates a number of taps (user touches) for each session ID based on a plurality of event information items stored by the data store unit 202. In this embodiment, the data collect unit 203 calculates a number of event information items having a common session ID as the number of taps of the session ID.

The data collect unit 203 assigns each session ID to an operation pattern corresponding to a combination of the plurality of parameters by the application type, the number of input parameters, and the number of taps. The application type is information for classifying the application screen into a group (hereinafter referred to as an “application screen group”). For example, the application type is information such as “scan”, “print”, etc. The “application screen group” is a group of a plurality of application screens having common features. In the present embodiment, a plurality of application screens having the same application type and the number of input parameters are classified into the same application screen group.

As a result, the data collect unit 203 classifies the plurality of event information stored by the data store unit 202 in units of session ID for each application screen group and for each operation pattern.

Next, the data collect unit 203 calculates a number of executions of the operation pattern for each application screen group and for each operation pattern, based on the classified event information. In this embodiment, the session ID is assigned for each execution. Therefore, the data collect unit 203 calculates the number of session IDs assigned to each operation pattern as the number of executions of each operation pattern.

The data collect unit 203 generates operation pattern information including the calculated number of executions, for each application screen group and for each operation pattern. In this embodiment, the operation pattern information includes a pattern identification (pattern ID), an application type, a number of input parameters, the number of taps, the number of executions, and the corresponding session ID. The pattern ID is identification information uniquely identifying the operation pattern. The application type, the number of input parameters, and the number of taps are key information of the operation pattern information. That is, a combination of the application type, the number of input parameters, and the number of taps is different for each operation pattern information item. For the corresponding session ID, one of the session IDs classified into the operation pattern is set. The event information of the session ID set to the corresponding session ID is used to generate the operation support information of the operation pattern.

Then, the data collect unit 203 registers the operation pattern information of the operation pattern having the largest number of executions calculated in the operation pattern information holding table 212 for each classified application screen group. The operation pattern information store table 212 will be described later, with reference to FIG. 8.

The operation support information generate unit 204 generates operation support information that indicates the operation sequence of a series of operations for the operation pattern having the largest number of executions calculated by the data collect unit 203 for each application screen group classified by the data collect unit 203. The operation pattern having the largest number of executions means, for example, an operation pattern in which the operation pattern information is registered in the operation pattern information store table 212.

For example, the operation support information generate unit 204 extracts a screen shot image from each of a plurality of pieces of event information having a session ID classified as an operation pattern having the largest number of executions stored in the event information store table 210. The operation support information generate unit 204 generates, as the operation support information, a plurality of extracted screen shot images associated with each other in chronological order. Then, the operation support information generate unit 204 stores the generated operation support information in the operation support information store unit 214.

The operation support information provide unit 205 reads the operation support information corresponding to the application screen from the operation support information store unit 214 and provides the operation support information to the MFP 14, when a series of operations on the application screen are performed in the MFP 14. In the MFP 14, the browser 14a displays the operation support information provided from the operation support information provide unit 205 on the operation panel 14c.

For example, each function of the service providing device 100 shown in FIG. 3 is realized by the CPU 101 executing a program stored in the ROM 102 or the HDD 104 in the service providing device 100. This program can be provided in a state introduced into the service providing device 100 in advance or it may be provided from the outside and introduced to the service providing device 100. In the latter case, this program can be provided by an external storage medium or provided by downloading from a server on a network. For example, the external storage medium is a Universal Serial Bus (USB) memory, a memory card, a Compact Disk Read Only Memory (CD-ROM), and the like. For example, the network is an Internet, etc.

(A Sequence Diagram for Data Store Process of an Operation Support Information Providing System 10)

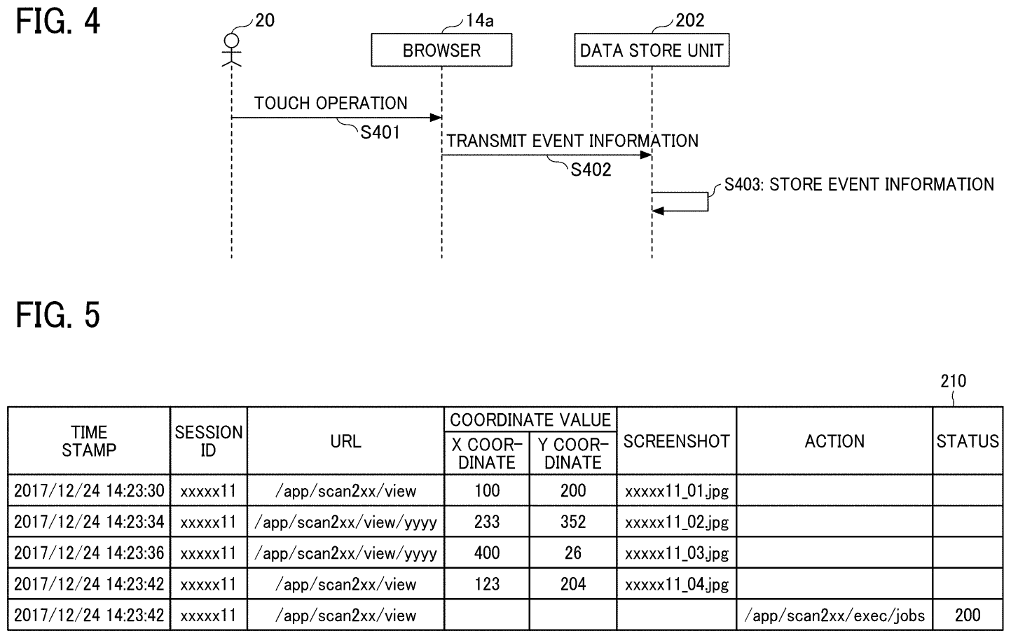

FIG. 4 illustrates an example of a sequence diagram for a data store process of an operation support information providing system 10 according to an embodiment. The process shown in FIG. 4 is executed by the operation information providing system 10 every time an event due to the touch operation by the user 20 occurs on the application screen displayed by the browser 14a.

First, the user 20 performs a touch operation on the application screen displayed by the browser 14a (step S401). The browser 14a generates event information corresponding to the touch operation and transmits the event information to the service providing device 100 via the network 12 (step S402). The event information includes the session ID, the URL, the coordinate value, and the screen shot image. In the service providing device 100, the data store unit 202 stores the event information by registering the event information transmitted from the browser 14a in the event information store table 210 (step S403).

(An Example of an Event Information Store Table 210)

FIG. 5 illustrates an example of an event information store table 210 according to an embodiment. The event information store table 210 shown in FIG. 5 is stored, for example, in a memory provided in the service providing device 100. The event information store table 210 can store a plurality of event information items by sequentially registering the event information by the data store unit 202.

In the example shown in FIG. 5, a plurality of pieces of event information corresponding to a series of operations on the application screen related to the scan function are stored in the event information store table 210. As shown in FIG. 5, each event information item includes the session ID, the URL, the coordinate value, and the screen shot image. For each event information item, a common session ID “xxxxx 11” is set. Therefore, it can be determined that the plurality of event information items is event information corresponding to a series of operations performed within a common session.

As shown in FIG. 5, for example, when each event information item is registered in the event information store table 210, a time stamp is recorded. Thus, it is possible to distinguish the generation order of the plurality of event information items (that is, the order of execution of the touch operations).

For each event information item, the URL and the coordinate values are set. Thus, it is possible to distinguish the application screen and the position to which the touch operation was made. For each event information item, the screen shot image is set. Thus, it is possible to visually distinguish the application screen and the position to which the touch operation was made.

As shown in FIG. 5, in the bottom row (line 5) of the event information store table 210, an execution log of the scan job is set. In the execution log of the scan job, the session ID “xxxxx 11” common to each event information item is set. Therefore, in the session, it is possible to determine that the target scan job has been executed after a series of operations specified by each event information item has been performed. That is, it is possible to determine that each event information item is effective as a series of operations for executing the scan job. Therefore, it is possible to determine that each event information item is effective as event information used for generating operation support information.

(A Flowchart for Operation Support Information Generate Process of a Service Providing Device 100)

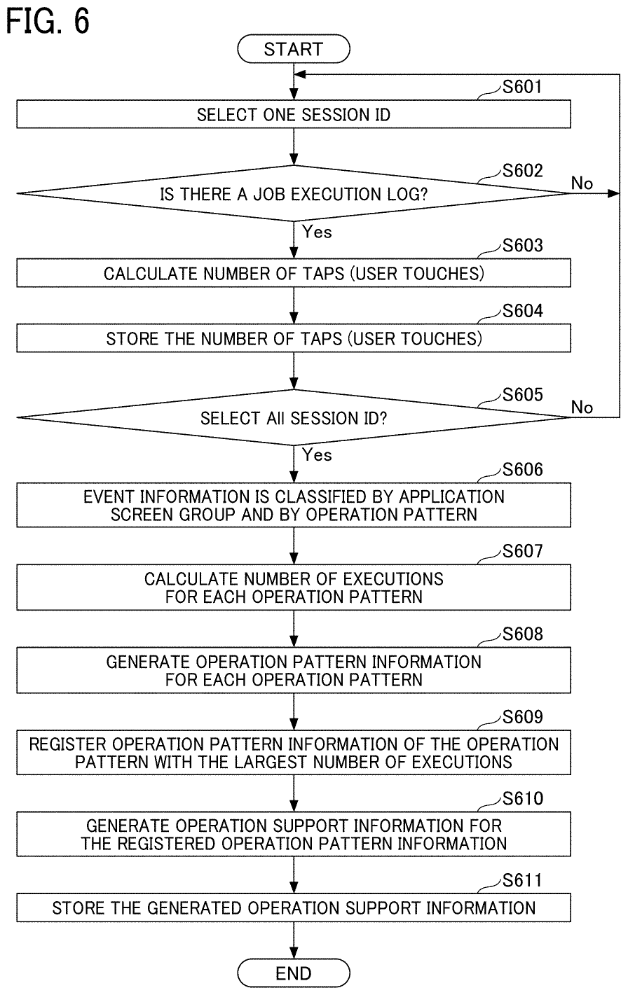

FIG. 6 illustrates an example of a flowchart for the operation support information generate process of a service providing device 100 according to an embodiment. The process shown in FIG. 6 can be executed at any timing, for example, periodically, at the timing of an execution request from the user, or a timing at which a predetermined event occurs, etc.

First, the data store unit 203 selects a session ID from the plurality of event information items stored by the data store unit 202 (step S601).

Next, the data store unit 203 judges whether the job execution log having the session ID selected in step S601 is stored in the event information store table 210 or not (step S602).

In step S602, if it is judged that the job execution log is not stored (step S602: No), the service providing device 100 returns the process to step S601.

In step S602, if it is judged that the job execution log is stored (step S602: Yes), the data collect unit 203 calculates the number of event information items having the session ID selected in step S601 as the number of taps of the session ID (step S603).

Then, the data collect unit 203 stores the number of taps calculated in step S603 in the memory in association with the session ID selected in step S601 (step S604).

Subsequently, the data collect unit 203 judges whether all the session IDs have been selected from the plurality of event information items stored in the event information store table 210 or not (step S605).

In step S605, if it is judged that all the session IDs have not been selected (step S605: No), the service providing device 100 returns the process to step S601. As a result, steps S601 to S605 are repeatedly executed, and the number of taps is calculated for all the session IDs in which the job execution log is stored.

In step S605, if it is judged that all the session IDs have been selected (step S605: Yes), the data collect unit 203 assigns each session ID, for which the number of taps is calculated in step S603, to the operation pattern corresponding to the combination of the plurality of parameters by the application type, the number of input parameters, and the number of taps. As a result, the data collect unit 203 classifies the plurality of event information stored by the event information store table 210 in units of session ID for the application screen group and for the operation pattern.

Next, the data collect unit 203 calculates the number of session IDs assigned to each operation pattern as the number of executions of each operation pattern based on the event information classified in step S606 (step S607).

Next, the data collect unit 203 generates the operation pattern information including the number of executions calculated in step S607 for the application screen group and the operation pattern (step S608). In this embodiment, the operation pattern information includes the pattern ID, the application type, the number of input parameters, the number of taps, the number of executions, and the corresponding session ID.

Then, the data collect unit 203 registers the operation pattern information of the operation pattern having the largest number of executions calculated in step S607 in the operation pattern information store table 212 for the application screen group (step S609).

After that, the operation support information generate unit 204 generates the operation support information indicating the operation sequence of a series of operations for the operation pattern having the largest number of executions calculated in step S607 for each application screen group (step S610).

Then, the operation support information generate unit 204 causes the operation support information store unit 214 to store the operation support information generated in step S610 (step S611). Thus, the service providing device 100 ends the series of processes shown in FIG. 6.

(An Example of Operation Pattern Information Generated by a Data Collect Unit 203)

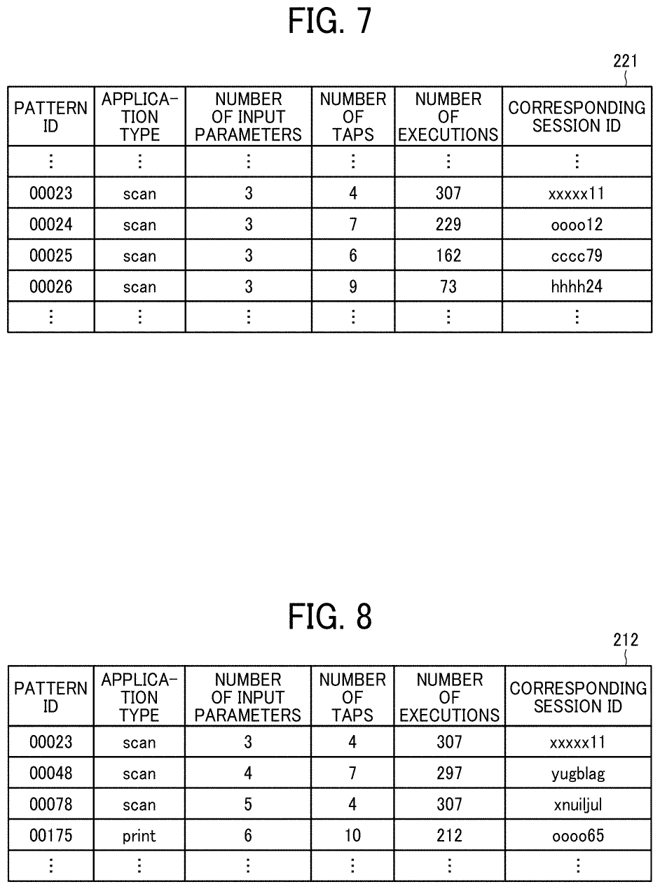

FIG. 7 illustrates an example of operation pattern information generated by a data collect unit 203 according to an embodiment.

As shown in FIG. 7, each operation pattern information item 221 generated by the data collect unit 203 includes the pattern ID, the application type, the number of input parameters, the number of taps, the number of executions, and the corresponding session ID.

Each operation pattern information item uses the application type, the number of input parameters, and the number of taps as key information. That is, the combination of the application type, the number of input parameters, and the number of taps is different for each operation pattern information.

For example, as shown in FIG. 7, the four operation pattern information items “00023”, “00024”, “00025”, and “00026” are shown as the pattern IDs. In all of the four operation pattern information items, “scan” is set as the application type and “3” is set as the number of input parameters (that is, the application screen group is common). However, the four operation pattern information items have a different number of taps. Therefore, the four operation pattern information items are different operation patterns.

(An Example of an Operation Pattern Information Store Table 212)

FIG. 8 illustrates an example of an operation pattern information store table 212 according to an embodiment. The operation pattern information store table 212 shown in FIG. 8 is stored, for example, in the memory of the service providing device 100. The operation pattern information store table 212 can hold a plurality of the operation pattern information items by registering the operation pattern information items obtained by the data collect unit 203. In this embodiment, the operation pattern information of the operation pattern having the largest number of executions is registered for each application screen group by the data collect unit 203 in the operation pattern information store table 212.

For example, as shown in FIG. 8, the operation pattern information item in which “00023” is set as the pattern ID is registered for the application screen group for which the application type is “scan” and the number of input parameters is “3”. This is because, among the four operation pattern information items shown in FIG. 7, the number of executions of the operation pattern information item in which “00023” is set as the pattern ID is the largest number (307).

(A Sequence Diagram for Application Screen Provide Process in an Operation Support Information Providing System 10)

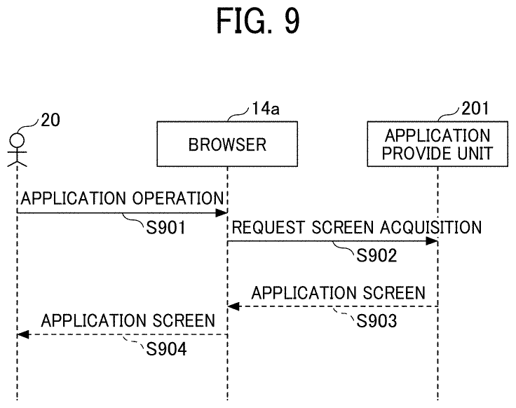

FIG. 9 illustrates an example of a sequence diagram for an application screen provide process in an operation support information providing system 10 according to an embodiment. The process shown in FIG. 9 is executed by the operation information providing system 10 every time the user 20 performs a predetermined application operation to the browser 14a. The predetermined application operation requests the application screen.

First, the user 20 performs a predetermined application operation on the browser 14a (step S901). The browser 14a transmits a screen acquisition request corresponding to the application operation to the service providing apparatus 100 via the network 12 (step S902). In the service providing device 100, the application provide unit 201 transmits an application screen corresponding to the screen acquisition request transmitted from the browser 14a to the browser 14a via the network 12 (step S903). The browser 14a presents the application screen to the user 20 by displaying the application screen transmitted from the application provide unit 201 on the operation panel 14c (step S904).

(A Sequence Diagram for an Operation Support Information Provide Process in an Operation Support Information Providing System 10)

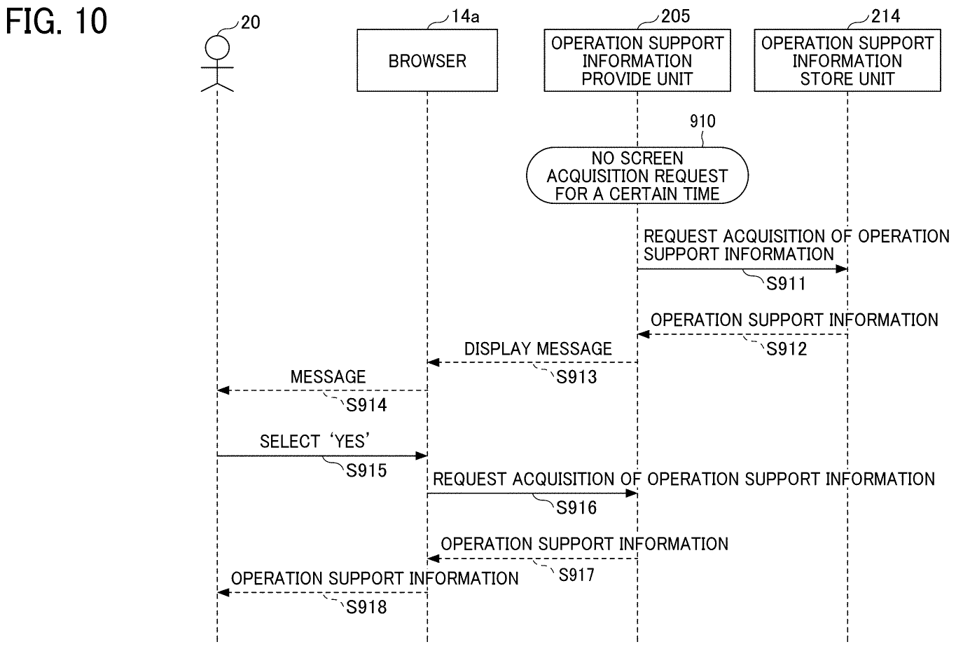

FIG. 10 illustrates an example of a sequence diagram for an operation support information provide process in an operation support information providing system 10 according to an embodiment. The process shown in FIG. 10 is executed by the operation information provide system 10 when the screen operation from the user 20 is not made to the browser 14a for a certain time (910).

First, in the service providing device 100, the operation support information provide unit 205 transmits an operation support information acquisition request to the operation support information store unit 214 (step S911). This acquisition request includes the application type and the number of input parameters for specifying the application screen group currently displayed on the browser 14a.

In response to the acquisition request transmitted from the operation support information provide unit 205, the operation support information store unit 214 transmits the operation support information corresponding to the combination of the application type and the number of input parameters included in the acquisition request to the operation support information providing unit 205 (step S912).

Next, the operation support information provide unit 205 transmits a message to the browser 14a via the network 12 to confirm to the user 20 whether operation support information is required or not (step S913). For example, the message is “Do you display common operating procedures?” The browser 14a presents the message to the user 20 by displaying the message transmitted from the operation support information provide unit 205 on the operation panel 14c (step S914). The user 20 can select “Yes” or “No” to the presented message.

Next, the user 20 performs an operation of selecting “YES” to the browser 14a according to the presented message (step S915). Then, the browser 14a transmits an acquisition request for the operation support information to the service providing device 100 via the network 12 (step S916).

In the service provide apparatus 100, the operation support information provide unit 205 transmits the operation support information acquired in step S912 to the browser 14a via the network 12 in response to the acquisition request transmitted from the browser 14a (step S917). The browser presents the operation support information to the user 20 by displaying the operation support information transmitted from the operation support information provide unit 205 on the operation panel 14c (step S918).

(An Example of an Application Screen)

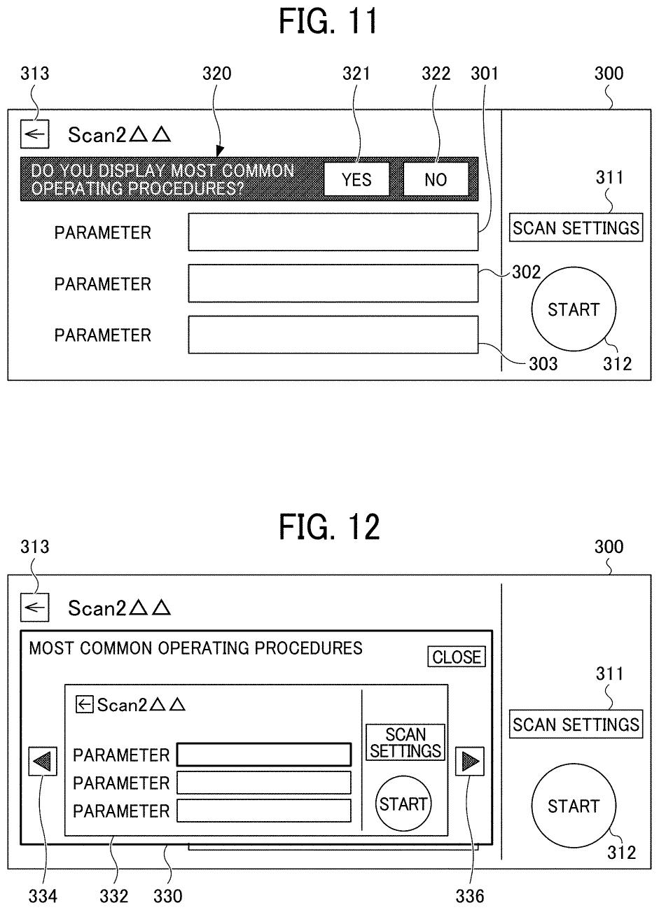

FIG. 11 illustrates an example of an application screen displayed on an operation panel 14c of a multifunction peripheral 14 in an operation support information providing system 10 according to an embodiment.

The application screen 300 shown in FIG. 11 is an example of an application screen displayed on the operation panel 14c of the MFP 14 and is an application screen for using the scan service provided from the service providing device 100.

The application screen 300 includes three parameter input fields 301, 302, and 303, a scan setting button 311, a start button 312, and a back button 313 that can be selected by a user operation.

For example, in the application screen 300, each time one of the objects is selected by a user operation, the browser 14a generates event information and transmits the event information to the service providing device 100 via the network 12.

As a result, the service providing device 100 can acquire and store a plurality of pieces of event information indicating the operation procedure of a series of operations on the application screen 300. Then, the service providing device 100 can generate the operation support information based on the plurality of pieces of event information.

The application screen 300 shown in FIG. 11 is a screen having an application type “scan” and the number of input parameters “3”.

Further, on the application screen 300, “Do you display most common operation procedures?” is displayed as the message 320 for confirming to the user 20 whether operation support information is required or not. Further, on the application screen 300, a “Yes” button 321 and a “No” button 322 for the user 20 to answer the message 320 are displayed. For example, the message 320, the “Yes” button 321, and the “No” button 322 are displayed on the application screen 300 when the screen operation from the user 20 is not made on the application screen 300 for a certain time.

When the “Yes” button 321 is selected by the user's operation on the application screen 300, the operation support information provided from the service providing apparatus 100 is displayed on the operation panel 14c. Details will be described with reference to FIG. 12.

(An Example of an Operation Support Information Offered to User 20)

FIG. 12 illustrates an example of operation support information offered to a user 20 in an operation support information providing system 10 according to an embodiment. In the example shown in FIG. 12, the operation support information display screen 330 is superimposed and displayed on the application screen 300 shown in FIG. 11. The operation support information display screen 330 is displayed under the control of the browser 14a in response to selection of the “Yes” button 321 by the user's operation on the application screen 300 shown in FIG. 11.

The operation support information display screen 330 includes a screen shot image 332. The screen shot image 332 is provided as operation support information from the operation support information provide unit 205 of the service providing device 100. The screen shot image 332 is one of a plurality of screen shot images showing the operation procedure of a series of operations.

The screen shot image 332 is a screen shot image of the application screen 300 obtained by the screen shot function of the MFP 14 in the past, and is generated by the operation support information generate unit 204 in the service providing device 100 as operation support information. That is, the screen shot image 332 represents the operation procedure of the operation pattern with the highest usage frequency in the application screen 300.

The screen shot image 332 is a screen shot image obtained when the parameter input field 301 is selected in a series of operations on the application screen 300. That is, the screen shot image 332 can present the selection order of the parameter input field 301 to the user 20 in a series of operations on the application screen 300.

The operation support information display screen 330 includes switch buttons 334 and 336. By selecting the switch buttons 334 or 336 by the user 20, it is possible to switch the screen shot image displayed on the operation support information display screen 330 to another screen shot image. Another screen shot image is any one of a plurality of screen shot images (for example, a screen shot image before or after the screen before switching) indicating a series of operation procedures provided as operation support information.

In this way, the service providing device 100 of the present embodiment displays, on the operation panel 14c, a screen shot image representing the operation procedure of the operation pattern with the highest usage frequency in the application screen currently displayed on the operation panel 14c. Therefore, the service providing device 100 of the present embodiment can present more useful operation support information to the user 20.

As explained above, the service providing device 100 according to the embodiment of the present disclosure generates operation support information indicating the operation procedure of a series of operations based on the event information of the MFP 14 stored in the event information store table 210. Then, it is possible to provide the generated operation support information to the MFP 14 that performs a series of operations. As a result, since the operation support information generated based on the actual operation history of the MFP 14 is provided to the MFP 14, the service providing device 100 can further enhance the accuracy of the operation manual information presented to the user 20. Further, since the service providing device 100 does not need to correlate the operation support information in advance, it is possible to appropriately generate appropriate operation support information and provide it to the MFP 14. Therefore, according to the service providing device 100, more appropriate operation support information can be presented to the user 20.

### A FIRST MODIFIED EXAMPLE

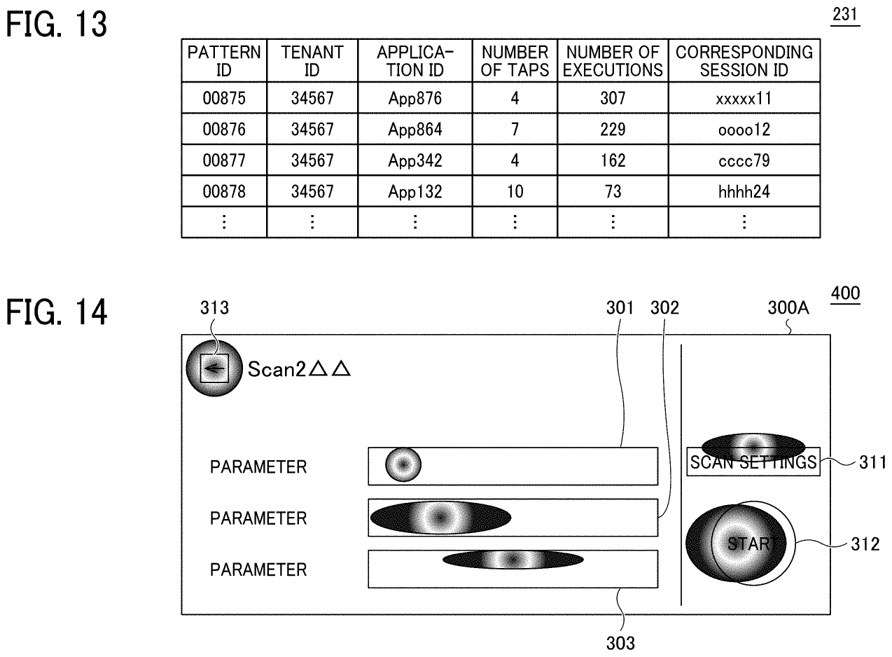

A first modified example of the above embodiment will be described with reference to FIG. 13. In the first modified example, changes from the above embodiment will be described. The other points are the same as those in the above embodiment, so the description is omitted.

In the above embodiment, the operation support information for each operation pattern is generated for each application screen group. The application screen group is a combination of the application type and the number of input parameters. In this first modified example, the operation support information generate unit 204 in the service providing device 100 generates the operation support information for each operation pattern by each tenant and each application. The tenant is information representing a group to which the MFP 14 belongs. The tenant can be a contract unit contracting a license of each application. Note that the tenant may include various contracting units such as a company, a business division, a department, a section, an official, a team, a floor, etc.

The service providing device 100 (data collect unit 203) in the first modified example collects event information by each tenant (for each tenant identification (tenant ID)) and for each application (for each application identification (application ID)). Then, the service providing device 100 (data collect unit 203) of the first modification generates operation pattern information by operation pattern for each tenant and each application.

FIG. 13 illustrates an example of an operation pattern information generated by a data collect unit 203 in the first modified example.

As shown in FIG. 13, each operation pattern information item 231 generated by the data collect unit 203 includes the pattern ID, the tenant ID, the application ID, the number of taps, the number of executions, and the corresponding session ID.

Each operation pattern information uses the tenant ID, the application ID, and the number of taps as key information. That is, the combination of the tenant ID, the application ID, and the number of taps is different for each operation pattern information.

For example, as shown in FIG. 13, the four operation pattern information items “00875”, “00876”, “00877”, and “00878” are the pattern IDs. In all of the four operation pattern information items, “34567” is set as the tenant ID. However, the four operation pattern information items have different application IDs. Therefore, the four operation pattern information items are different operation patterns.

The operation support information generate unit 204 of the first modified example generates operation support information using event information of an operation pattern having the largest number of executions for each tenant and each application. Furthermore, the operation support information provide unit 205 provides operation support information corresponding to the tenant to which the MFP 14 belongs and corresponding to the application currently being executed by the MFP 14, to the MFP 14.

Thereby, the service providing device 100 can generate the operation support information based on the event information obtained in the past from a plurality of terminal devices (including the MFP 14) of the tenant to which the MFP 14 belongs. Furthermore, the service providing device 100 can generate the operation support information using the screen shot image of the same application screen as the application screen currently displayed on the MFP 14. Therefore, more accurate operation support information can be presented to the user 20.

### A SECOND MODIFIED EXAMPLE

A second modified example of the above embodiment will be described with reference to FIG. 14. In the second modified example, changes from the above embodiment will be described. The other points are the same as those in the above embodiments, so the description is omitted. In this second modified example, the operation support information generate unit 204 generates a heat map as the operation support information. The heat map represents the operation position and the operation frequency on the application screen using the screen shot image of one application screen.

For example, the data collect unit 203 of the second modified example classifies a plurality of pieces of event information on the same application screen by operation position of the application screen. The classification by operation position of the application screen uses the coordinate value set in the event information.

Then, the data collect unit 203 of the second modified example calculates the number of pieces of event information classified as the operation position for each operation position of the application screen.

The operation support information generate unit 204 in the second modified example generates the heat map having different display colors according to the number of pieces of event information by using the screen shot image of the application screen based on the number of pieces of event information for each operation position. The heat map visualizes the part touched frequently by the user with the display color. The heat maps are often used for analyzing user operations of web pages.

Then, the operation support information provide unit 205 of the second modified example provides the MFP 14 with a heat map generated using the same application screen as the application screen currently displayed on the MFP 14. The browser 14a of the MFP 14 displays the provided heat map on the operation panel 14c. As a result, the user 20 can intuitively grasp the selection frequency of each object on the currently used application screen. Therefore, the user 20 can easily judge which object should be selected.

FIG. 14 illustrates an example of the heat map offered to the user 20 in an operation support information providing system 10 according to the second modified example.

The heat map 400 shown in FIG. 14 is generated as operation support information by the operation support information generate unit 204 in the service providing apparatus 100. This heat map 400 is generated using the screen shot image 300A. The screen shot image 300A is a screen shot image of the application screen 300 (see FIG. 11) obtained by the screen shot function of the MFP 14 in the past. In FIG. 14, in the screen shot image 300A, the same objects as those of the application screen 300 are denoted by the same reference numerals.

In the heat map 400, each operation position is colored with a display color corresponding to the operation frequency based on predetermined data representing the correspondence relationship between the operation frequency and the display color. For example, in the heat map 400, the operation position with a higher operation frequency is colored with a display color with a redder component. Further, the operation position with a lower operation frequency is colored with a display color with a bluer component. An example of the operation frequency is the number of times the user has touched a predetermined position on the screen.

With this heat map 400, the user 20 can intuitively grasp a plurality of objects on which the selection operation has been performed and the selection frequency of each object on the currently used application screen 300. Therefore, the user 20 can easily judge which object should be selected.

The above-described embodiments are illustrative and do not limit the present disclosure. Thus, numerous additional modifications and variations are possible in light of the above teachings. For example, elements and/or features of different illustrative embodiments may be combined with each other and/or substituted for each other within the scope of the present disclosure. Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA), and conventional circuit components arranged to perform the recited functions.

For example, the apparatus capable of executing and displaying the application may be a projector (PJ), Interactive White Board (IWB), i.e., a whiteboard having an electronic blackboard function capable of mutual communication, an output device such as a digital signage, a Head Up Display (HUD), an industrial machinery, an imaging device, a sound collector, a medical device, a network home appliance, a personal computer, a mobile phone, a smartphone, a tablet terminal, a game machine, a Personal Digital Assistant (PDA), a digital camera, a wearable PC, a desktop PC or the like.

1. An operation support information providing apparatus, comprising;
a memory;
processing circuitry configured to
store, in the memory, operation history information transmitted from a terminal device, the operational history information including a record of a series of touches performed by at least one user on a touchscreen of the terminal device in order to perform an operation procedure that includes a series of operations for executing a specific function;
generate, based on the stored operation history information, operation support information indicating, for a particular operation procedure, a particular operation pattern that includes a particular series of operations for executing the specific function; and
provide the operation support information to the terminal device to aid an operator of to the terminal device to perform the specific function.

2. The operation support information providing apparatus of claim 1, wherein the processing circuitry is further configured to generate the operation support information for the particular operation procedure by selecting, from among all operation patterns for performing the specific function that are stored as part of the operation history information, the particular operation pattern, which has a highest usage frequency among the stored operation patterns for the particular operation.

3. The operation support information providing apparatus of claim 1, wherein the processing circuitry is configured to generate the operation support information for the particular operation procedure, which is defined by an application type and a number of input parameters.

4. The operation support information providing apparatus of claim 1, wherein the processing circuitry is further configured to
generate the operation support information for a plurality of operation patterns, each associated with an application identifier; and
provide the operation support information corresponding to the application identification to the terminal device on which the series of operations are performed to aid an operator of to the terminal device to perform the specific function.

5. The operation support information providing apparatus of claim 1, wherein the processing circuitry is further configured to
generate the operation support information for each tenant of a plurality of tenants; and
provide the operation support information corresponding to each tenant to which the terminal device belongs to the terminal device to aid an operator of to the terminal device to perform the specific function.

6. The operation support information providing apparatus of claim 1, wherein the processing circuitry is further configured to
generate the operation support information for the particular operation procedure for a plurality of operation patterns that are classified based on a number of touches used to perform the specific function.

7. The operation support information providing apparatus of claim 1, wherein the processing circuitry is further configured to
generate the operation support information including at least one screen shot image of the operation screen, the screen shot being obtained by the terminal device.

8. The operation support information providing apparatus of claim 1, wherein the processing circuitry is further configured to
generate the operation support information, which includes a heat map that represents an operation position and an operation frequency on the operation screen, and that is generated by using a screen shot image of the operation screen acquired by the terminal device.

9. An operation support information providing system, comprising;
a terminal device; and
an operation support information providing device, including
a memory; and
processing circuitry configured to
store, in the memory, operation history information transmitted from a terminal device, the operational history information including a record of a series of touches performed by at least one user on a touchscreen of the terminal device in order to perform an operation procedure that includes a series of operations for executing a specific function;
generate, based on the stored operation history information, operation support information indicating, for a particular operation procedure, a particular operation pattern that includes a particular series of operations for executing the specific function; and
provide the operation support information to the terminal device to aid an operator of to the terminal device to perform the specific function.

10. A non-transitory computer-readable medium storing a program that when executed by a computer, causes the computer to perform a method comprising:
storing, in the memory, operation history information transmitted from a terminal device, the operational history information including a record of a series of touches performed by at least one user on a touchscreen of the terminal device in order to perform an operation procedure that includes a series of operations for executing a specific function;
generating, based on the stored operation history information, operation support information indicating, for a particular operation procedure, a particular operation pattern that includes a particular series of operations for executing the specific function; and
providing the operation support information to the terminal device to aid an operator of to the terminal device to perform the specific function.
